(19) United States
(12) Patent Application Publication
(10) Pub. No.: US 2007/0000087 A1
(43) Pub. Date: Jan. 4, 2007

(54) Door hinge

(76) Inventors: Jenn Chyuan Hour, Waipu Township (TW); Chang Kuen Chang, Waipu Township (TW)

Correspondence Address: PRO-TECHTOR INTERNATIONAL SERVICES, 20775 NORADA CT., SARATOGA, CA, 95070, US

(21) Appl. No.: 11/174,058

(22) Filed: Jun. 30, 2005

(51) Int. Cl. E05F 3/20

(52) U.S. Cl. 16/50

(57) ABSTRACT

Provided is a door hinge assembly including hinges each comprising upper and lower connecting units each comprising a plate secured to door or door frame, and a cylinder having a toothed bore; a first rotational unit inserted into the cylinder of the upper connecting unit and comprising a first slope; and a second rotational unit comprising an upper shaft snugly inserted into the first rotational unit, a second slope, and a lower cylinder having a toothed surface inserted into the cylinder of the lower connecting unit. The first slope of each hinge engages the second slope thereof when the hinges are not swung. The upper connecting unit of each hinge swings from a closed position to an open position by pushing. The first slope moves from the highest point of the second slope to the lowest point thereof in response to releasing the pushing force for closing the door.

### BACKGROUND OF THE INVENTION

1. Field of Invention

The present invention relates to hinges and more particularly to an improved hinge mounted on a door.

2. Related Art

A conventional door hinge has one side secured to a door frame and the other side secured to a door. A person may have to use one hand to close the door after opening. This is somewhat inconvenient if both hands are not available. Another conventional hinge for overcoming the above drawback is implemented as a piston-cylinder based hinge or a spring hinge. For the piston-cylinder based hinge, it is relatively expensive. For the spring hinge, only automatic door closing function is provided rather than a temporary positioning of the opened door including a temporary positioning of the door not being fully opened. Thus, the need for improvement still exists.

### SUMMARY OF THE INVENTION

It is therefore an object of the present invention to provide a door hinge assembly including a plurality of hinges each comprising upper and lower connecting units each comprising a plate and a cylinder at one side of the plate, the cylinder including a plurality of longitudinal teeth equally spaced along a bore thereof wherein the plate of the upper connecting unit is secured to a door and the plate of the lower connecting unit is secured to a door frame; a first rotational unit comprising an upper sleeve inserted into the cylinder of the upper connecting unit, a lower enlargement, an intermediate annular toothed section on a shoulder between the sleeve and the lower enlargement, the toothed section inserted into the cylinder of the upper connecting unit for matingly engaging therewith, and a first slope having a lowest point within the lower enlargement and a highest point externally of a bottom of the lower enlargement; and a second rotational unit comprising an upper rotatable shaft snugly inserted into the sleeve through the lower enlargement, an intermediate enlargement, a second slope on a shoulder between the shaft and the intermediate enlargement and having a highest point and a lowest point, the second slope engaged the first slope, and a lower cylinder including a plurality of longitudinal teeth equally spaced along an outer surface thereof and inserted into the cylinder of the lower connecting unit for matingly engaging therewith, wherein the first slope of each hinge is matingly engaged with the second slope thereof when the hinges are not swung; wherein the upper connecting unit of each hinge is adapted to swing from a closed position of the door to an open position thereof by pushing the door; and wherein the first slope moves from the highest point of the second slope to the lowest point thereof in response to releasing of the pushing force, thereby automatically closing the door.

In one aspect of the present invention, the cylinder of the second rotational unit is formed by extruding and the cylinder of each connecting unit is formed by extruding.

In another aspect of the present invention, there are further provided a helical spring put on the shaft, the spring having a lower end engaged a shoulder between the sleeve and the shaft, an annular groove formed on the shaft proximate a top thereof, and a C-shaped clamp mounted on the groove, the clamp urged by an upper end of the spring, wherein the spring is adapted to compress as the upper connecting unit of each hinge swings from the closed position to the open position.

In a further aspect of the present invention, in response to moving the first slope from the lowest point of the second slope to the highest point thereof the first slope moves further to a second highest point of the second slope by pushing the door and stops there temporarily.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of door hinge according to the invention;

FIG. 2 is an exploded perspective view of two hinges of the invention to be mounted between a door and a door frame;

FIG. 3 is a plan view in part section of the assembled hinge in a nonoperating position;

FIG. 4 is a view similar to FIG. 3 where the hinge is disposed in an operating position after swinging;

FIG. 5 is a plan view of FIG. 4; and

FIG. 6 is a top view of a fully open door incorporating the hinge in a position shown in FIG. 5.

### DETAILED DESCRIPTION OF THE INVENTION

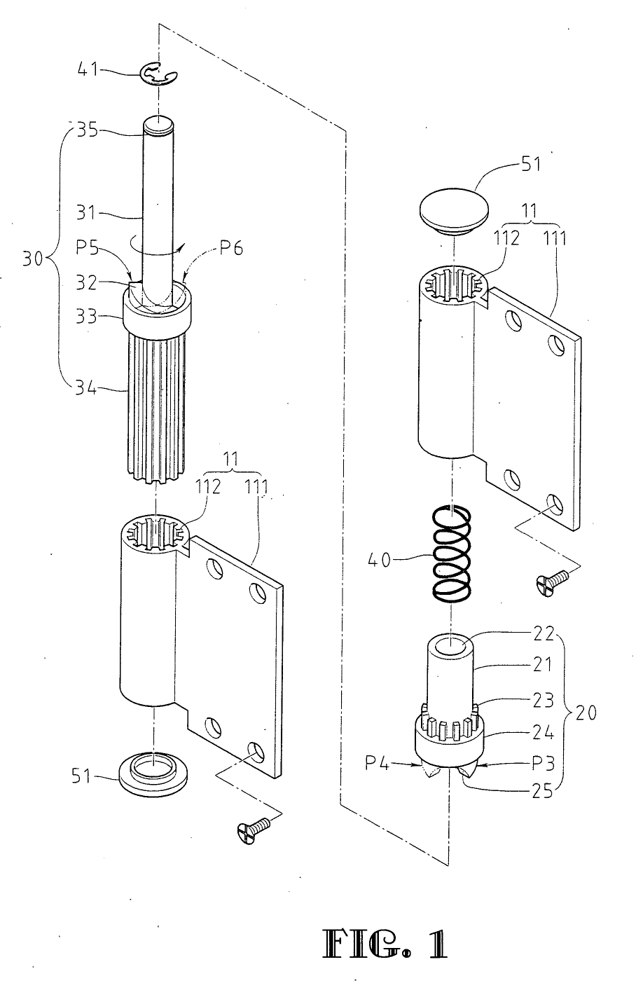

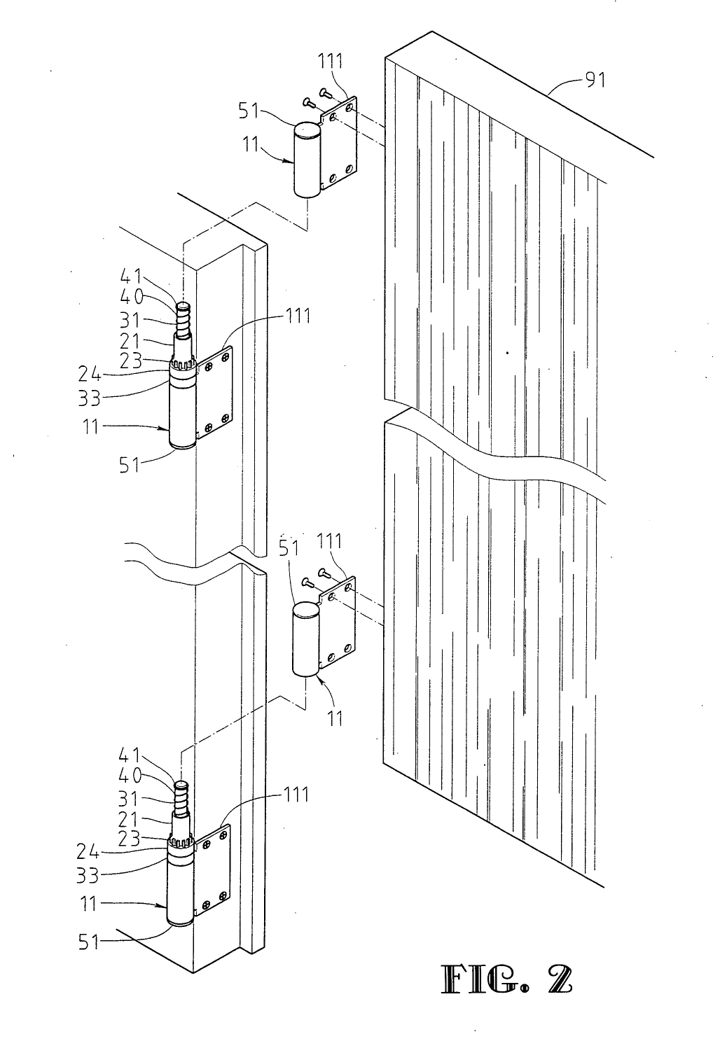

Referring to FIGS. 1, 2 and 3, there is shown a door hinge constructed in accordance with a preferred embodiment of the invention. The hinge is made of aluminum and comprises two connecting units 11, a first rotational unit 20, and a second rotational unit 30. Each component is discussed in detailed below.

The connecting unit 11 comprises a rectangular plate 111, and a cylinder 112 integrally formed with a projecting side of the plate 111, the cylinder 112 including a plurality of longitudinal teeth equally spaced along a bore thereof. Preferably, the integral plate 111 and cylinder 112 are formed by extruding.

The first rotational unit 20 comprises an upper sleeve 21 inserted into the cylinder 112 of an upper connecting unit 11, the sleeve 21 having a bore 22, a lower enlargement 24, an intermediate annular toothed section 23 on a shoulder between the sleeve 21 and the enlargement 24, the toothed section 23 adapted to insert into the cylinder 112 of the upper connecting unit 11 for matingly engaging therewith such that a smooth joining portion is formed between the cylinder 112 of the upper connecting unit 11 and the cylindrical enlargement 24, and a first slope 25 having a lowest point within the enlargement 24 and a highest point externally of a bottom of the enlargement 24.

The second rotational unit 30 comprises an upper rotatable shaft 31 snugly inserted into the bore 22 of the sleeve 21 through the enlargement 24, an intermediate enlargement 33, a second slope 32 on a shoulder between the shaft 31 and the enlargement 33, the second slope 32 engaged the first slope 25, and a lower cylinder 34 including a plurality of longitudinal teeth equally spaced along an outer surface thereof, the cylinder 34 adapted to insert into the cylinder 112 of a lower connecting unit 11 for matingly engaging therewith such that a smooth joining portion is formed between the cylinder 112 of the lower connecting unit 11 and the cylindrical enlargement 33. In the shown embodiment, the plate 111 of the upper connecting unit 11 is threadedly secured to a door 91 and the plate 111 of the lower connecting unit 11 is threadedly secured to a door frame. Also preferably, the cylinder 34 is formed by extruding.

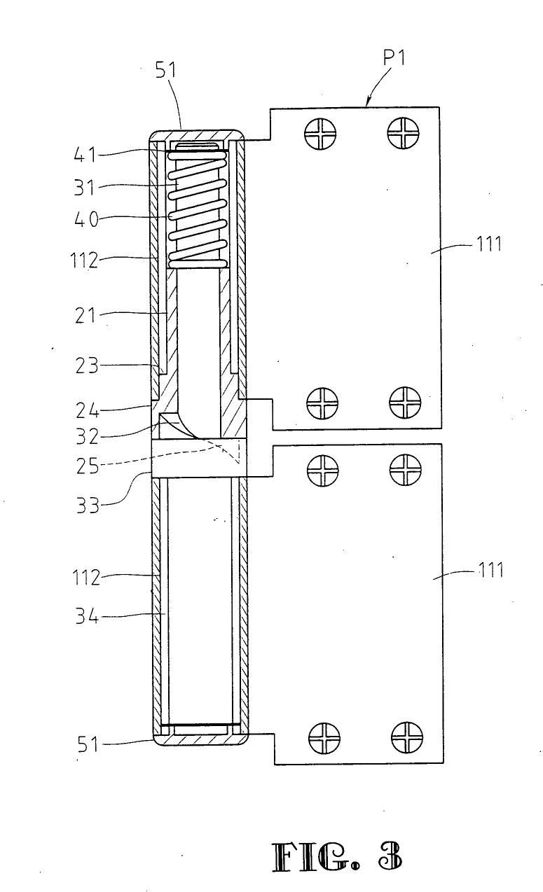

Referring to FIG. 3 specifically, the first slope 25 of the first rotational unit 20 is matingly engaged with the second slope 32 of the second rotational unit 30. In this engagement, both the first slope 25 and the second slope 32 are concealed by the enlargements 24 and 33 such that a visually aesthetic hinge can be seen as it is mounted between a door and a door frame.

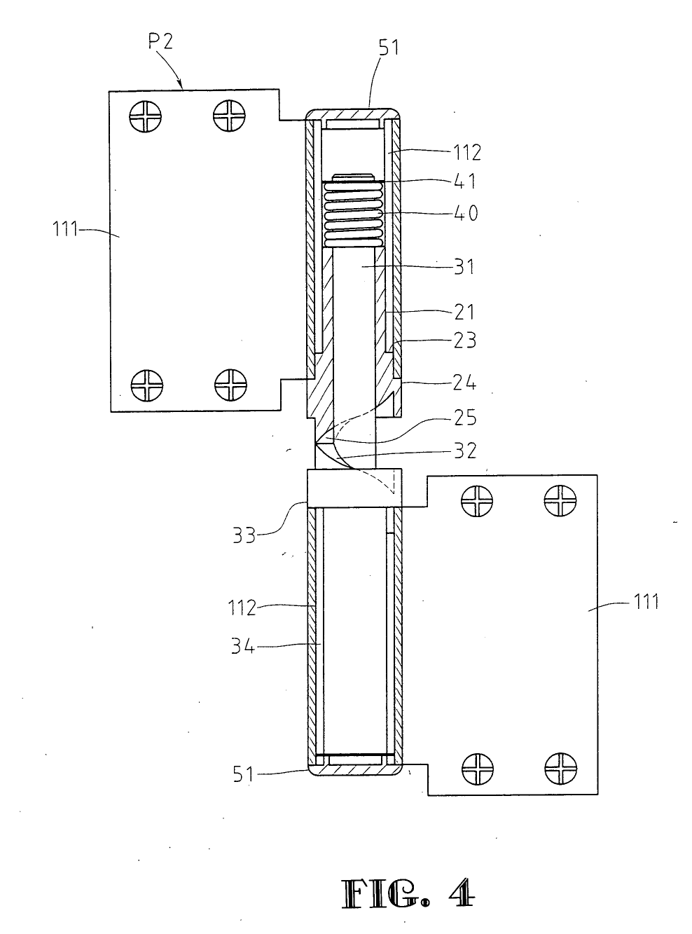

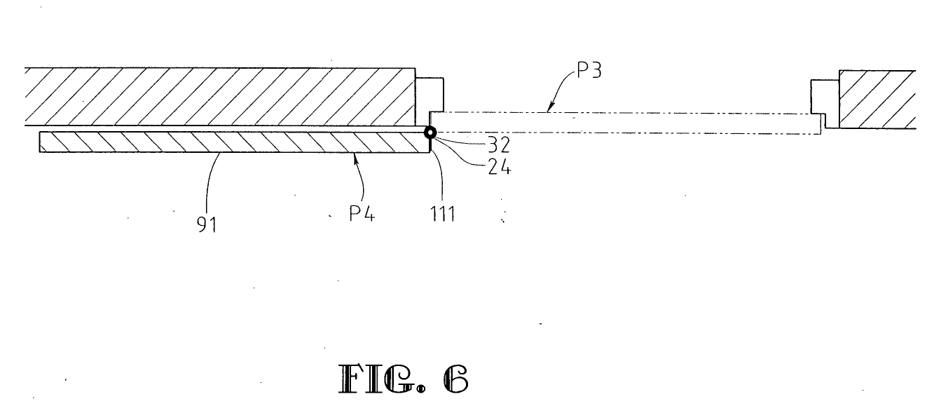

Referring to FIGS. 4, 5, and 6 in conjunction with FIG. 3, the upper connecting unit 11 of a hinge (i.e., one secured to the door 91) is adapted to swing from a first position P1 in FIG. 3 (or the door 91 at a third position P3 in FIG. 6) to a second position P2 in FIG. 4 (or the door 91 at a fourth position P4 in FIG. 6) by pushing the door 91. The first rotational unit 20 swings the same since the cylinder 112 of the upper connecting unit 11 is matingly engaged with the toothed section 23. The first slope 25 of the first rotational unit 20 rides along the second slope 32 of the second rotational unit 30 during the swing. The first slope 25 of the first rotational unit 20 moves from the highest point of the second slope 32 of the second rotational unit 30 to the lowest point thereof due to gravitation in response to releasing of the pushing force (i.e., the door 91 automatically returns to its closed position).

Preferably, a helical spring 40 is put on the shaft 31. The spring 40 has a lower end engaged a shoulder between the sleeve 21 and the shaft 35. Also, a C-shaped clamp 41 is mounted on an annular groove 35 proximate a top of the shaft 35. The clamp 41 is urged by an upper end of the spring 40. The spring 40 is adapted to compress as the upper connecting unit 11 of the hinge swings from the first position P1 in FIG. 3 to the second position P2 in FIG. 4 such that in a subsequent door closing operation the movement of the first slope 25 of the first rotational unit 20 from the highest point of the second slope 32 of the second rotational unit 30 to the lowest point thereof can be facilitated due to the expansion of the spring 40.

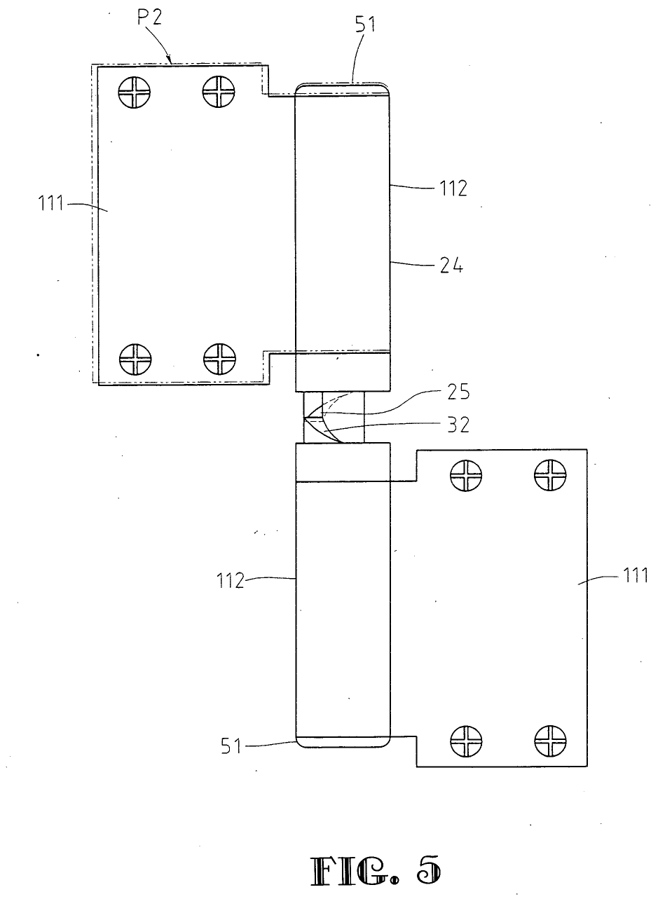

Referring to FIGS. 5 and 6 again, after the first slope 25 moving from the lowest point of the second slope 32 to the highest point thereof the first slope 25 is pushed further to move a second highest point of the second slope 32 (i.e., lowered) and position there because it is stopped by a wall. Such arrangement aims at temporarily positioning the door 91 (i.e., the door 91 remained open) for, for example, facilitating many times of object movement via the door 91. To the contrary, a reverse operation will move the first slope 25 from the second highest point of the second slope 32 to the highest point of the second slope 32.

Also, the door 91 is adapted to temporarily fasten in a desired position between the fully open position and the closed position after pushing the door 91 to the desired position by swinging about the hinges. Preferably, covers 51 are provided on top and bottom ends of the hinge (i.e., at a top end of the cylinder 112 of the upper connecting unit 11 and at a bottom end of the cylinder 112 of the lower connecting unit 11 respectively. The provision of covers 51 is for aesthetic purpose and for preventing foreign objects from falling into the hinge.

Referring to FIG. 1 again, in a case of a door detached from the upper connecting unit 11, turn the first slope 25 of the first rotational unit 20 from the third position P3 to the fourth position P4 and next engage the toothed section 23 with the cylinder 112. As a result, a relative positioning (i.e., angle) of the upper connecting unit 11 with respect to the first rotational unit 20 can be changed. Similarly, turn the first slope 25 of the second rotational unit 30 from a fifth position P5 to a sixth position P6 can also change a relative positioning (i.e., angle) of second rotational unit 30 with respect to the lower connecting unit 11.

While the invention herein disclosed has been described by means of specific embodiments, numerous modifications and variations could be made thereto by those skilled in the art without departing from the scope and spirit of the invention set forth in the claims.

What is claimed is:

1. A door hinge assembly including a plurality of hinges each comprising:
upper and lower connecting units each comprising a plate and a cylinder at one side of the plate, the cylinder including a plurality of longitudinal teeth equally spaced along a bore thereof wherein the plate of the upper connecting unit is secured to a door and the plate of the lower connecting unit is secured to a door frame;
a first rotational unit comprising an upper sleeve inserted into the cylinder of the upper connecting unit, a lower enlargement, an intermediate annular toothed section on a shoulder between the sleeve and the lower enlargement, the toothed section inserted into the cylinder of the upper connecting unit for matingly engaging therewith, and a first slope having a lowest point within the lower enlargement and a highest point externally of a bottom of the lower enlargement; and
a second rotational unit comprising an upper rotatable shaft snugly inserted into the sleeve through the lower enlargement, an intermediate enlargement, a second slope on a shoulder between the shaft and the intermediate enlargement and having a highest point and a lowest point, the second slope engaged the first slope, and a lower cylinder including a plurality of longitudinal teeth equally spaced along an outer surface thereof and inserted into the cylinder of the lower connecting unit for matingly engaging therewith,
wherein the first slope of each hinge is matingly engaged with the second slope thereof when the hinges are not swung; wherein the upper connecting unit of each hinge is adapted to swing from a closed position of the door to an open position thereof by pushing the door; and wherein the first slope moves from the highest point of the second slope to the lowest point thereof in response to releasing of the pushing force, thereby automatically closing the door.

2. The door hinge assembly of claim 1, wherein the cylinder of the second rotational unit is formed by extruding and the cylinder of each connecting unit is formed by extruding.

3. The door hinge assembly of claim 1, further comprising a helical spring put on the shaft, the spring having a lower end engaged a shoulder between the sleeve and the shaft, an annular groove formed on the shaft proximate a top thereof, and a C-shaped clamp mounted on the groove, the clamp urged by an upper end of the spring, wherein the spring is adapted to compress as the upper connecting unit of each hinge swings from the closed position to the open position.

4. The door hinge assembly of claim 1, wherein in response to moving the first slope from the lowest point of the second slope to the highest point thereof the first slope moves further to a second highest point of the second slope by pushing the door and stops there temporarily.
